(19) United States
(12) Patent Application Publication
(10) Pub. No.: US 2015/0098227 A1
(43) Pub. Date: Apr. 9, 2015

(54) LIGHT SOURCE MODULE OF LAMP FOR VEHICLE

(71) Applicant: Hyundai Motor Company, Seoul (KR)

(72) Inventor: Jeong Gyu Yang, Yongin-si (KR)

(73) Assignee: Hyundai Motor Company, Seoul (KR)

(21) Appl. No.: 14/504,985

(22) Filed: Oct. 2, 2014

(30) Foreign Application Priority Data
Oct. 7, 2013 (KR) 10-2013-0119467

(51) Int. Cl. F21S 8/10

(52) U.S. Cl. CPC F21S 48/234; F21S 48/215; F21S 48/238; F21Y 2101/02
USPC 362/301

(57) ABSTRACT

A light source module of a lamp for a vehicle, may include an LED light source, a PCB substrate configured to control a supply of current to the LED light source, and a film coupled to a front surface of the PCB substrate, integrally formed with a plurality of reflecting protrusions and implementing a 3D image while reflecting light from the LED light source toward an outer lens.

### CROSS REFERENCE TO RELATED APPLICATION

The present application claims priority to Korean Patent Application No. 10-2013-0119467, filed Oct. 7, 2013, the entire contents of which is incorporated herein for all purposes by this reference.

### BACKGROUND OF THE INVENTION

1. Field of the Invention

The present invention relates to a light source module of a lamp for a vehicle, and more particularly, to a light source module that is part of a rear combination lamp.

2. Description of Related Art

Generally, a rear combination lamp for a vehicle is collectively called lamps which are mounted at a rear portion of the vehicle and includes a back lamp turned on when a driver shifts into a reverse gear, a brake lamp turned on when a driver presses a brake pedal, a direction indication lamp, and the like.

Recently, a use of a rear combination lamp using a light emitting diode (LED) having long lifespan and high light efficiency as a light source is a growing trend. As illustrated in FIG. 1, a light source module 10 of the existing rear combination lamp includes an LED light source 11, a PCB substrate 12 configured to control a supply of current to the LED light source 11, a reflecting plate 13 configured to reflect light from the LED light source 11 toward an outer lens 21, and a light diffusion lens 14 configured to be mounted in front of the reflecting plate 13 to diffuse the light from the LED light source 11.

However, the existing light source module 10 as described above has a configuration in which the reflecting plate 13 is mounted in front of the LED light source 11 and therefore a size of the whole optical system including the LED light source 11 and the outer lens 21 is increased, such that a freedom of design may be reduced, a weight may be heavy, and costs may rise.

Further, the existing light source module 10 uses a method of converting the light from the LED light source 11 into simple light emitting images such as a point, a line, and a surface and irradiating the images, and therefore has low visibility. For this reason, in order to improve the visibility, the number of LED light sources 11 needs to be increased and therefore costs may be greatly increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a light source module of a lamp for a vehicle capable of implementing a bezel image by a hidden effect due to light collection and deposition when a light source is not turned on and implementing a three-dimensional image when the light source is turned on.

Various aspects of the present invention are directed to providing a light source module of a lamp for a vehicle capable of promoting luxuriousness by implementing a bezel image and saving costs by improving visibility without increasing the number of light sources by implementing a three-dimensional image

Various aspects of the present invention are additionally directed to providing reduction in size and weight of an optical system and saving costs by a configuration in which a separate reflector is not mounted in front of a light source.

According various embodiments of the present invention, a light source module of a lamp for a vehicle may include an LED light source, a PCB substrate configured to control a supply of current to the LED light source, and a film coupled to a front surface of the PCB substrate, integrally formed with a plurality of reflecting protrusions and implementing a 3D image while reflecting light from the LED light source toward an outer lens.

The light source module may further include a resin coupled to a front surface of the film, formed with the reflecting protrusion and guiding a movement of the light from the LED light source to the film.

The light source module may further include a back cover enclosing and fixing the PCB substrate, the film, and the resin and preventing the light from the LED light source from being directly exposed to an outside.

The light source module may further include a silver reflecting coating integrally coupled to a rear surface of the film facing the PCB substrate, reflecting the light from the LED light source scattered backward to a front of the light source module when the LED light source is turned on and implementing a hidden effect due to deposition when the LED light source is not turned on.

The light source module may further include a bezel integrally coupled to a front surface of the resin along an edge of the resin, preventing the light from the LED light source directed toward the outer lens from being directly output forward when the LED light source is turned on and implementing a bezel image due to the deposition together with the silver reflecting coating when the LED light source is not turned on.

Each reflecting protrusion may be formed at a position at which a pattern image is to be implemented on the film and the LED light source may be mounted to be positioned at a side portion of the plurality of reflecting protrusions.

The plurality of reflecting protrusion may be formed to protrude in a vertical direction to a direction of the light from the LED light source directed toward the outer lens while being formed at a position at which a pattern image is implemented on the film and the LED light source may be mounted to be positioned at a side portion of the plurality of reflecting protrusions.

Each reflecting protrusion may be formed to protrude in a triangular section shape or a semi-spherical section shape from the film so that the 3D image is implemented by a prism effect when the light from the LED light source is reflected toward the outer lens.

### BRIEF DESCRIPTION OF THE DRAWINGS

FIG. 1 is a diagram for describing a light source module of a rear combination lamp for a vehicle according to the related art.

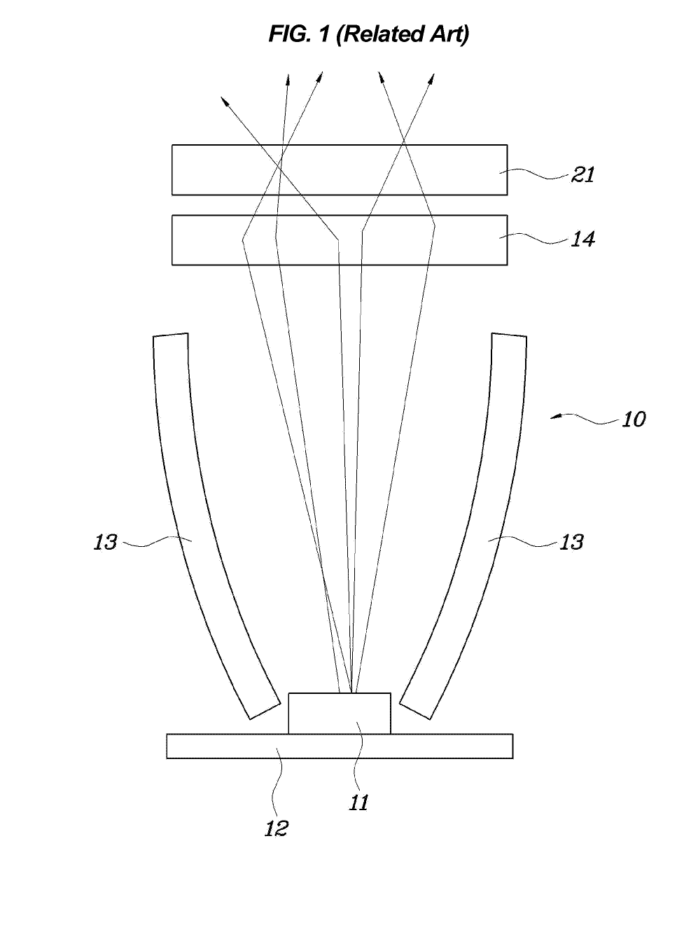

FIG. 2 is a diagram for describing an exemplary light source module of a rear combination lamp for a vehicle according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

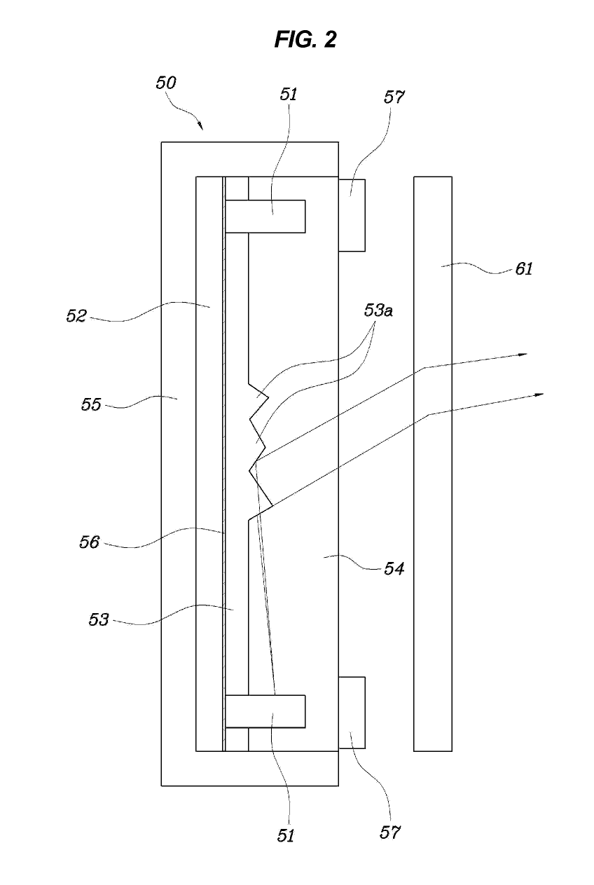

As illustrated in FIG. 2, a light source module 50 of a rear combination lamp for a vehicle according to various embodiments of the present invention includes an LED light source 51, a PCB substrate 52 configured to control a supply of current to the LED light source 51, and a film 53 configured to be coupled to a front surface of the PCB substrate 52 and integrally formed with a plurality of reflecting protrusions 53a to implement a 3D image while reflecting light from the LED light source 51 toward an outer lens 61.

In this configuration, one end of the LED light source 51 is electrically connected to the PCB substrate 52 and the other end thereof is mounted to be erected toward a front of the light source module at which the outer lens 61 is present.

The reflecting protrusion 53a is formed to protrude in a vertical direction to a direction of the light from the LED light source 51 while being formed at a position at which a pattern image is to be implemented on the film 53 and the LED light source 51 is mounted to be positioned at a side portion of the reflecting protrusion 53a.

The LED light source 51 may be mounted in plural around the reflecting protrusion 53a and if necessary, the plurality of LED light sources 51 may be mounted at equidistance along a circumferential direction.

When the reflecting protrusion 53a reflects the light from the LED light source 51 toward the outer lens 61, the reflecting protrusion 53a may be formed to protrude in various shapes, such as a triangular section shape, a semi-spherical section shape, and if necessary, a polygonal section shape, from the film 53, as a micro pattern to implement the 3D image by a prism effect and as the reflecting protrusion is away from the LED light source 51, intensity (luminance) of light from the LED light source 51 is gradually reduced. By the above principle, the light from the LED light source 51 reflected from the reflecting protrusion 53a is made visible in a 3D shape with the naked eye as if descending down, thereby implementing the 3D image.

Further, according to various embodiments of the present invention, the light source module further includes a resin 54 coupled to a front surface of the film 53 formed with the reflecting protrusion 53a and guiding a movement of the light from the LED light source 51 to the film 53.

The resin 54 is a medium for delivery the light from the LED light source 51 to the film 53 and the light from the LED light source 51 may be guided to the reflecting protrusion 53a of the film 53 through the medium, thereby improving light efficiency.

As the resin 54, an ultraviolet-ray (UV) curable resin may be used, but the various embodiments of the present invention are not limited thereto.

Further, according to various embodiments of the present invention, the light source module 50 may further include a back cover 55 configured to enclose and fix the PCB substrate 52, the film 53, and the resin 54 and prevent the light from the LED light source 51 from being directly exposed to the outside.

Further, according to various embodiments of the present invention, the light source module 50 may further include a silver reflecting coating 56 integrally coupled with a rear surface of the film 53 facing the PCB substrate 52 and a bezel 57 integrally coupled with a front surface of the resin 54 along an edge.

The silver reflecting coating 56 serves to again reflect the light from the LED light source 51 scattered backward to the front of the light source module when the LED light source 51 is turned on, and to the contrary, the silver reflecting coating 56 serves to implement luxuriousness by the hidden effect due to the deposition when the LED light source 51 is not turned on.

Most of the light from the LED light source 51 is output to the outer lens 61 by the reflecting protrusion 53a of the film 53 to implement the 3D image, but a phenomenon in which some of the light is not reflected to the reflecting protrusion 53a and is scattered to a back at which the PCB substrate 52 is present occurs. The silver reflecting coating 56 according to the exemplary embodiment of the present invention serves to again reflect the light from the LED light source 51 scattered backward to the reflecting protrusion 53a of the film 53.

That is, the silver reflecting coating 56 according to various embodiments of the present invention again reflects the light from the LED light source 51 scattered to the back of the light source module at which the PCB substrate 52 is present to the reflecting protrusion 53a, and thus the light loss due to the scattered light may be greatly reduced and may secure an additional quantity of light, thereby greatly improving the light efficiency of the lamp.

Further, the silver reflecting coating 56 may implement the hidden effect due to the deposition when the LED light source 51 is not turned on, thereby greatly helping implement the luxuriousness of the lamp.

Further, when the LED light source 51 is turned on, the bezel 57 serves to prevent the light from the LED light source 51 from being directly output to the front at which the outer lens 61 is present, and to the contrary, when the LED light source 51 is not turned on, the bezel 57 implements the bezel image due to the deposition together with the silver reflecting coating 56, thereby more improving the luxury image of the lamp.

When the light from the LED light source 51 is reflected to the reflecting protrusion 53a and then is output forward, the 3D image according to various embodiments of the present invention may be implemented, but when the light from the LED light source 51 is directly output forward, the 3D image may not be implemented. To prevent this, in the front of the LED light source 51, the bezel 57 is coupled to the resin 54.

As described above, according to various embodiments of the present invention, when the LED light source 51 is turned on, the 3D image may be implemented by the reflecting protrusion 53a of the film 53, and to the contrary, when the LED light source 51 is not turned on, the bezel image may be implemented by the hidden effect due to the deposition using the silver reflecting coating 56 and the bezel 57, thereby further improving the luxuriousness of the lamp.

Further, according to various embodiments of the present invention, the light from the LED light source 51 scattered backward using the silver reflecting coating 56 may be again reflected to the reflecting protrusion 53a of the film 53 and thus the light loss due to the scattered light may be greatly reduced and the additional quantity of light may be secured, thereby greatly improving the light efficiency of the lamp.

Additionally, according to various embodiments of the present invention, the additional quantity of light may be secured and the light efficiency of the lamp may be improved by the silver reflecting coating 56 and thus the visibility may be maximally secured with the minimum number of LED light sources 51, thereby saving costs.

Further, the light source module according to various embodiments of the present invention has a structure in which the reflecting protrusion 53a formed in the film 53 reflects the light from the LED light source 51 forward and therefore does not require the reflecting plate in front of the LED light source as in the related art, and thus the size of the whole optical system including the light source and the lens is greatly reduced, thereby improving the freedom in design and promoting the decrease in weight and costs.

According to various embodiments of the present invention, it is possible to further improve the luxuriousness of the lamp by implementing the 3D image due to the reflecting protrusion of the film when the LED light source is turned on and implementing the bezel image by the hidden effect due to the deposition using the silver reflecting coating and the bezel when the LED light source is not turned on and secure the additional quantity of light by again reflecting the light from the LED light source scattered backward to the reflecting protrusion of the film using the silver reflecting coating and thus greatly improve the light efficiency of the lamp.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A light source module of a lamp for a vehicle, comprising:
an LED light source;
a PCB substrate configured to control a supply of current to the LED light source; and
a film coupled to a front surface of the PCB substrate, integrally formed with a plurality of reflecting protrusions and implementing a 3D image while reflecting light from the LED light source toward an outer lens.

2. The light source module of claim 1, further comprising:
a resin coupled to a front surface of the film, formed with the reflecting protrusion, and guiding the light from the LED light source to the film.

3. The light source module of claim 2, further comprising:
a back cover enclosing and fixing the PCB substrate, the film, and the resin and preventing the light from the LED light source from being directly exposed to an outside.

4. The light source module of claim 1, further comprising:
a silver reflecting coating integrally coupled to a rear surface of the film, facing the PCB substrate, reflecting light from the LED light source scattered backward to a front of the light source module when the LED light source is turned on and implementing a hidden effect due to deposition when the LED light source is not turned on.

5. The light source module of claim 4, further comprising:
a bezel integrally coupled to a front surface of the resin along an edge of the resin, preventing the light from the LED light source directed toward the outer lens from being directly output forward when the LED light source is turned on and implementing a bezel image due to the deposition together with the silver reflecting coating when the LED light source is not turned on.

6. The light source module of claim 1, wherein each reflecting protrusion is formed at a position at which a pattern image is to be implemented on the film, and
the LED light source is mounted to be positioned at a side portion of the plurality of reflecting protrusions.

7. The light source module of claim 1, wherein the plurality of reflecting protrusions are formed to protrude in a vertical direction to a direction of the light from the LED light source directed toward the outer lens while being formed at a position at which a pattern image is implemented on the film, and
the LED light source is mounted to be positioned at a side portion of the plurality of reflecting protrusions.

8. The light source module of claim 1, wherein each reflecting protrusion is formed to protrude in a triangular section shape or a semi-spherical section shape from the film so that the 3D image is implemented by a prism effect when the light from the LED light source is reflected toward the outer lens.
